(19) United States
(12) Patent Application Publication
(10) Pub. No.: US 2024/0393495 A1
(43) Pub. Date: Nov. 28, 2024

(54) FLOOD EVENT IDENTIFICATION METHOD AND APPARATUS, ELECTRONIC DEVICE, AND READABLE STORAGE MEDIUM

(71) Applicant: CHINA THREE GORGES CORPORATION, Wuhan (CN)

(72) Inventors: Mengjie LI, Wuhan (CN); Zhaokai YIN, Wuhan (CN); Hailei MOU, Wuhan (CN); Lili LIANG, Beijing (CN); Kun LIU, Wuhan (CN); Hongbing ZHU, Wuhan (CN); Zhiwu LIU, Beijing (CN); Di WU, Wuhan (CN); Weiwei LU, Wuhan (CN); Bei LU, Wuhan (CN); Heng YANG, Wuhan (CN); Zeang GUO, Wuhan (CN); Zhi XU, Wuhan (CN); Bo ZHANG, Wuhan (CN)

(21) Appl. No.: 18/669,808

(22) Filed: May 21, 2024

Related U.S. Application Data
(63) Continuation of application No. PCT/CN2023/098622, filed on Jun. 6, 2023.

(30) Foreign Application Priority Data
Jun. 24, 2022 (CN) 202210730964.6

(51) Int. Cl. G01V 20/00

(52) U.S. Cl. CPC G01V 20/00

(57) ABSTRACT

Disclosed in the present disclosure are a flood event identification method and apparatus, an electronic device, and a readable storage medium. The method includes: obtaining runoff time sequence data; obtaining initial peak occurrence time by using N continuous first-order difference values in a first-order difference sequence of the runoff time sequence data; obtaining initial start and end time by using M continuous first-order difference values in the first-order difference sequence; and screening out determined peak occurrence time from the initial peak occurrence time, and screening out start and end time corresponding to the peak occurrence time from the initial start and end time. With the technical solution provided by the present disclosure, flood events can be automatically selected with high efficiency and accuracy.

### CROSS-REFERENCE TO RELATED APPLICATIONS

This application is a bypass continuation application of PCT application no.: PCT/CN2023/098622. This application claims priorities from PCT Application PCT/CN2023/098622, filed Jun. 6, 2023, and from Chinese patent application 202210730964.6, filed Jun. 24, 2022, the contents of which is incorporated herein in the entirety by reference.

### TECHNICAL FIELD

The present disclosure relates to the technical field of data processing, and specifically, to a flood event identification method and apparatus, an electronic device, and a readable storage medium.

### BACKGROUND

In the application of technologies such as river basin flood forecasting and parameter calibration of hydrological models, a large number of flood events in many years are needed. Flood event selection refers to a process of extracting floods from continuous runoff observation data to obtain information such as flood peak discharges, peak occurrence time, start and end time, and flood volumes of flood events. Conventional flood event selection methods are mainly manual empirical selections, which have subjective selection results and are inefficient in case of a large amount of data.

### SUMMARY

In view of this, embodiments of the present disclosure provide a flood event identification method and apparatus, an electronic device, and a readable storage medium, to solve the problems of subjective selection results and low efficiency of manual selection of flood events.

According to a first aspect, an embodiment of the present disclosure provides a flood event identification method, including:
obtaining runoff time sequence data;
obtaining initial peak occurrence time by using N continuous first-order difference values in a first-order difference sequence of the runoff time sequence data, where N is a positive integer;
obtaining initial start and end time by using M continuous first-order difference values in the first-order difference sequence, where M is a positive integer; and
screening out determined peak occurrence time from the initial peak occurrence time, and screening out start and end time corresponding to the peak occurrence time from the initial start and end time.

Optionally, the obtaining initial peak occurrence time by using N continuous first-order difference values in a first-order difference sequence of the runoff time sequence data includes:
if a first first-order difference value corresponding to first runoff data in the runoff time sequence data and N−1 first-order difference values continuous with the first first-order difference value meet a first condition, determining that time corresponding to the first runoff data is initial peak occurrence time, where the first condition includes the first first-order difference value and N/2−1 continuous first-order difference values before the first first-order difference value being all greater than or equal to zero, and N/2 continuous first-order difference values after the first first-order difference value being all less than or equal to zero, N being an even number greater than zero.

Optionally, the first condition further includes an absolute value of the first first-order difference value and an absolute value of a first-order difference value next to the first first-order difference value being both greater than a preset threshold.

Optionally, the obtaining initial start and end time by using M continuous first-order difference values in the first-order difference sequence includes:

if a second first-order difference value corresponding to second runoff data in the runoff time sequence data and M−1 first-order difference values continuous with the second first-order difference value meet a second condition, determining that time corresponding to the second runoff data is initial start and end time, where the second condition includes the second first-order difference value and M/2−1 continuous first-order difference values before the second first-order difference value being all less than or equal to zero, and M/2 continuous first-order difference values after the second first-order difference value being all greater than or equal to zero, M being an even number greater than zero.

Optionally, the screening out determined peak occurrence time from the initial peak occurrence time, and screening out start and end time corresponding to the peak occurrence time from the initial start and end time includes:
screening out the initial peak occurrence time at which a corresponding runoff volume is greater than or equal to a preset flood peak threshold as the determined peak occurrence time;
screening out the initial start and end time earlier than and closest to the peak occurrence time as start time; and
screening out the initial start and end time later than and closest to the peak occurrence time as end time.

Optionally, the obtaining runoff time sequence data includes:
obtaining original runoff time sequence data; and
smoothing the original runoff time sequence data to obtain the runoff time sequence data;
where after screening out the determined peak occurrence time from the initial peak occurrence time, and screening out the start and end time corresponding to the peak occurrence time from the initial start and end time, the method further includes:
obtaining partial original runoff data between the start time and the end time from the original runoff time sequence data;
screening out a maximum runoff volume from the partial original runoff data; and
if the maximum runoff volume is greater than or equal to the preset flood peak threshold, determining that the maximum runoff volume is the flood peak discharge, and correcting the peak occurrence time to time corresponding to the maximum runoff volume.

Optionally, after screening out the determined peak occurrence time from the initial peak occurrence time, and screening out the start and end time corresponding to the peak occurrence time from the initial start and end time, the method further includes:
determining a flood peak discharge corresponding to the peak occurrence time;
respectively obtaining difference multiples of flood peak discharges and fluctuation point discharges of two continuous floods, where each of the difference multiples is a multiple obtained by dividing a first difference by a second difference; for a previous flood, the first difference is a difference between the flood peak discharge and a start discharge, and the second difference is a difference between the flood peak discharge and an end discharge; and for a next flood, the first difference is a difference between the flood peak discharge and an end discharge, and the second difference is a difference between the flood peak discharge and a start discharge; and
if the two difference multiples are both greater than or equal to a difference multiple threshold, the start discharge of the previous flood is less than or equal to the end discharge, the start discharge of the next flood is greater than or equal to the end discharge, and a difference between start time of the next flood and end time of the previous flood is less than or equal to an average duration of flood events that is determined based on characteristics of a river basin, determining that the two floods are multi-peak floods.

According to a second aspect, an embodiment of the present disclosure provides a flood event identification apparatus, including:
a data obtaining module configured to obtain runoff time sequence data;
a first determination module configured to obtain initial peak occurrence time by using N continuous first-order difference values in a first-order difference sequence of the runoff time sequence data, where N is a positive integer;
a second determination module configured to obtain initial start and end time by using M continuous first-order difference values in the first-order difference sequence, where M is a positive integer; and
a third determination module configured to screen out determined peak occurrence time from the initial peak occurrence time, and screen out start and end time corresponding to the peak occurrence time from the initial start and end time.

According to a third aspect, an embodiment of the present disclosure provides an electronic device, including:
a memory and a processor, where the memory is in communication connection with the processor, the memory is configured to store a computer program, and when the computer program is executed by the processor, the flood event identification method according to the first aspect above is implemented.

According to a fourth aspect, an embodiment of the present disclosure provides a computer-readable storage medium, where the computer-readable storage medium is configured to store a computer program, and when the computer program is executed by a processor, the flood event identification method according to the first aspect above is implemented.

According to the flood event identification method and apparatus, the electronic device, and the readable storage medium provided by the embodiments of the present disclosure, the initial peak occurrence time is obtained by using the N continuous first-order difference values in the first-order difference sequence of the runoff time sequence data, the initial start and end time is obtained by using the M continuous first-order difference values in the first-order difference sequence, and finally the determined peak occurrence time is screened out from the initial peak occurrence time, and the start and end time corresponding to the peak occurrence time is screened out from the initial start and end time, such that flood events can be automatically selected with high efficiency and accuracy.

### BRIEF DESCRIPTION OF THE DRAWINGS

The features and advantages of the present disclosure will be more clearly understood by reference to the accompanying drawings, which are schematic and are not to be construed as limiting the present disclosure in any way, in which:

FIG. 1 is a schematic flowchart of a flood event identification method provided by an embodiment of the present disclosure;

FIG. 2 is a schematic diagram of original runoff data and preprocessed runoff data provided by an embodiment of the present disclosure;

FIG. 3 is a schematic diagram of runoff data obtained by performing two-step smoothing on preprocessed runoff data provided by an embodiment of the present disclosure;

FIG. 4 is a schematic diagram of a preliminary selection result of flood events provided by an embodiment of the present disclosure;

FIG. 5 is a schematic diagram of a selection result of flood events after combination of multi-peak floods provided by an embodiment of the present disclosure;

FIG. 6 is a schematic structural diagram of a flood event identification apparatus provided by an embodiment of the present disclosure; and

FIG. 7 is a schematic structural diagram of an electronic device provided by an embodiment of the present disclosure.

### DETAILED DESCRIPTION OF THE EMBODIMENTS

To make the objectives, technical solutions and advantages of the embodiments of the present disclosure clearer, the technical solutions in the embodiments of the present disclosure will be clearly and completely described below with reference to the accompanying drawings in the embodiments of the present disclosure. Apparently, the described embodiments are some rather than all of the embodiments of the present disclosure. All other embodiments obtained by those of ordinary skill in the art based on the embodiments of the present disclosure without creative efforts fall within the scope of protection of the present disclosure.

It is to be noted that the term “include/comprise”, “contain” or any other variant thereof is intended to cover a non-exclusive inclusion, such that a process, method, commodity or device including a series of elements includes not only those elements, but also other elements not expressly listed, or further includes elements inherent to such process, method, commodity or device. Without further limitation, an element defined by a statement “includes one . . . ” does not preclude the presence of other identical elements in the process, method, commodity or device including the elements. In addition, the terms such as “first” and “second” are only used for descriptive purposes, and cannot be construed as indicating or implying relative importance or implying the number of technical features indicated. In the description of the embodiments below, “a plurality of” means two or more, unless otherwise expressly and specifically defined.

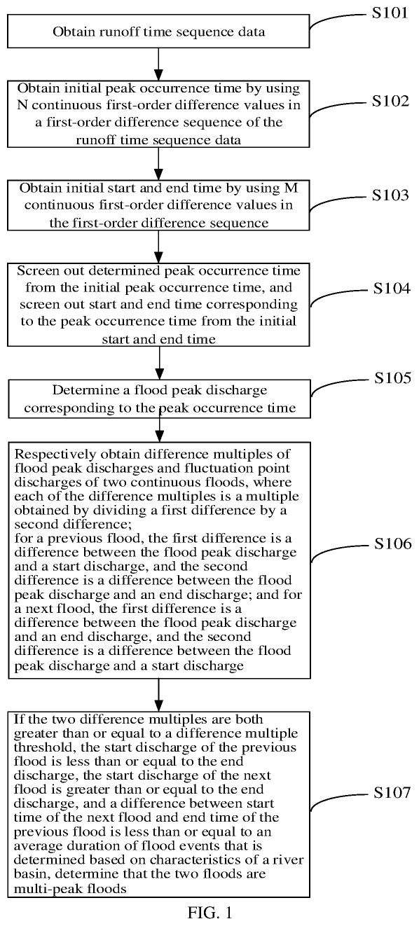

Referring to FIG. 1, an embodiment of the present disclosure provides a flood event identification method, including:
S101: obtaining runoff time sequence data, where the runoff time sequence data may specifically be runoff observation data with a continuous time sequence in a research area;
S102: obtaining initial peak occurrence time by using N continuous first-order difference values in a first-order difference sequence of the runoff time sequence data, where N is a positive integer; the first-order difference sequence refers to a sequence obtained by sequentially performing first-order difference on data in the runoff time sequence data, and the first-order difference refers to the next data minus the previous data; and the initial peak occurrence time is possible peak occurrence time and can form initial peak occurrence time set;
S103: obtaining initial start and end time by using M continuous first-order difference values in the first-order difference sequence, where M is a positive integer; and the initial start and end time can form initial start and end time set; and
S104: screening out determined peak occurrence time from the initial peak occurrence time, and screening out start and end time corresponding to the peak occurrence time from the initial start and end time. Herein, a flood peak discharge may be a runoff volume corresponding to the peak occurrence time in the runoff time sequence data.

According to the flood event identification method provided by this embodiment of the present disclosure, the initial peak occurrence time is obtained by using the N continuous first-order difference values in the first-order difference sequence of the runoff time sequence data, the initial start and end time is obtained by using the M continuous first-order difference values in the first-order difference sequence, and finally the determined peak occurrence time is screened out from the initial peak occurrence time, and the start and end time corresponding to the peak occurrence time is screened out from the initial start and end time, such that flood events can be automatically selected with high efficiency and accuracy.

In addition, after screening out the determined peak occurrence time from the initial peak occurrence time, and screening out the start and end time corresponding to the peak occurrence time from the initial start and end time, the method further includes:
S105: determining a flood peak discharge corresponding to the peak occurrence time;
S106: respectively obtaining difference multiples of flood peak discharges and fluctuation point discharges of two continuous floods, where each of the difference multiples is a multiple obtained by dividing a first difference by a second difference; for a previous flood, the first difference is a difference between the flood peak discharge and a start discharge, and the second difference is a difference between the flood peak discharge and an end discharge; and for a next flood, the first difference is a difference between the flood peak discharge and an end discharge, and the second difference is a difference between the flood peak discharge and a start discharge; and
S107: if the two difference multiples are both greater than or equal to a difference multiple threshold, the start discharge of the previous flood is less than or equal to the end discharge, the start discharge of the next flood is greater than or equal to the end discharge, and a difference between start time of the next flood and end time of the previous flood is less than or equal to an average duration of flood events that is determined based on characteristics of a river basin, determining that the two floods are multi-peak floods.

In this embodiment of the present disclosure, the multi-peak floods are screened out by using the difference multiple thresholds & of the flood peak discharges and the fluctuation point discharges of the continuous floods. For example, for two continuous floods, peak occurrence time thereof is denoted as t₁ [symbol] t₂ (t₁ [symbol] t₂) respectively, corresponding start time and end time of the floods are sty st₁ [symbol] st₂ [symbol] et₁ [symbol] et₂ respectively, flood peak discharges are xₜ_{₁} [symbol] xₜ_{₂} respectively, and start discharges and end discharges are qxₛₜ_{₁} [symbol] qxₛₜ_{₂} [symbol] qxₑₜ_{₁} [symbol] qxₑₜ_{₂} respectively. T is the average duration of the flood events that is determined based on the characteristics of the river basin, and if it meets the following conditions:

$$( {x}_{{t}_{1}} - {qx}_{{st}_{1}} ) / ( {x}_{{t}_{1}} - {qx}_{{et}_{1}} ) > α , {qx}_{{et}_{1}} \geq {qx}_{{st}_{1}} , {st}_{2} - {et}_{1} \leq T ;$$

$$( {x}_{{t}_{2}} - {qx}_{{et}_{2}} ) / ( {x}_{{t}_{2}} - {qx}_{{st}_{2}} ) > α , {qx}_{{st}_{2}} \geq {qx}_{{et}_{2}} ;$$

then, it is determined that the two floods are multi-peak floods, and the two floods are combined into one with the start time being st₁ and the end time being et₂; if xₜ_{₁}≥xₜ_{₂}, a peak occurrence time of the combined flood is t₁; and if xₜ_{₁}<xₜ_{₂}, the peak occurrence time of the combined flood is t₂.

Specifically, the obtaining runoff time sequence data includes:
obtaining original runoff time sequence data which may be, for example, original runoff observation data with the continuous time sequence in the research area, and can be denoted as x₁, x₂, . . . , xₙ, where n is the total number of time points; and
performing preprocessing on the original runoff time sequence data to obtain the runoff time sequence data, where the preprocessing includes removal of abnormal mutation point data and/or interpolation of missing data. Specifically, after the abnormal mutation point data is removed, the removed data is marked as the missing data. The interpolation may be linear interpolation. The following embodiments of the present disclosure may be implemented based on the preprocessed runoff time sequence data which may be denoted as qx₁, qx₂, . . . , qxₙ.

In addition, smoothing may further be performed on the preprocessed runoff time sequence data qx₁, qx₂, . . . , qxₙ, where the smoothing may be two-step smoothing, specifically as follows:

Window sizes of two-step smoothing are set as win1 and win2, and weight coefficients ω₁ⱼ and ω₂ⱼ are calculated respectively, and formulas are as follows:

$${ω}_{1 j} = \{ \begin{matrix}1 / win 1 , 1 \leq j \leq win 1 \\ 0 , win 1 < j \leq n\end{matrix}$$

$${ω}_{2 j} = \{ \begin{matrix}1 / win 2 , 1 \leq j \leq win 2 \\ 0 , win 2 < j \leq n\end{matrix}$$

Then a result after one-step moving average is

$${y}_{1 , j} = {\sum }_{k = 1}^{j + 1} {qx}_{k} \cdot {ω}_{1 ( j + 2 - k )} ,$$

and a result after two-step moving average is

$${y}_{2 , j} = {\sum }_{k = 1}^{j + 1} {y}_{1 , k} \cdot {ω}_{2 ( j + 2 - k )} , where 1 \leq j \leq n .$$

In this embodiment of the present disclosure, the two-step smoothing is performed on the runoff data, and a good smoothing effect is achieved, such that the accuracy of flood peak selection is improved, and the problem that the start and end time of flood events are too long can be avoided. The two-step smoothing on the runoff data also enables the flood event identification method provided by this embodiment of the present disclosure to be applicable to runoff observation data with fluctuation and oscillation.

Certainly, in some specific embodiments, preprocessing or smoothing may be performed on only the original runoff time sequence data.

In some optional specific embodiments, the obtaining initial peak occurrence time by using N continuous first-order difference values in a first-order difference sequence of the runoff time sequence data includes:

if a first first-order difference value corresponding to first runoff data in the runoff time sequence data and N−1 first-order difference values continuous with the first first-order difference value meet a first condition, determining that time corresponding to the first runoff data is initial peak occurrence time, where the first condition includes the first first-order difference value and N/2−1 continuous first-order difference values before the first first-order difference value being all greater than or equal to zero, and N/2 continuous first-order difference values after the first first-order difference value being all less than or equal to zero, N being an even number greater than zero.

A first-order difference of data y_{2,j} after two-step smoothing is denoted as y_{2,j}¹, where j=2, . . . , n. Therefore, if y_{2,j}¹≥0, y_{2,j-1}¹≥0, y_{2,j-2}¹≥0, . . . , y_{2,j-N/2+1}¹≥0, and y_{2,j+1}¹≤0, y_{2,j+2}¹≤0, . . . y_{2,j+N/2}¹≤0, j is the initial peak occurrence time, where y_{2,j}¹ is the first first-order difference value, y_{2,j-1}¹, y_{2,j-2}¹, . . . , y_{2,j-N/2+1}¹ are the N/2−1 continuous first-order difference values before the first first-order difference value, and y_{2,j+1}, y_{2,j+2}¹, . . . , y_{2,j+N/2}¹ are the N/2 continuous first-order difference values after the first first-order difference value.

In addition, if the runoff time sequence data is obtained by means of two-step smoothing, the first runoff data is other runoff data except the first Eve_Win pieces of runoff data and the last Eve_Win pieces of runoff data, that is, a value range of the j above is Eve_Win+1≤j≤n−Eve_Win, where Eve_Win=(win1+win2)/2, and win1, win2 are the window sizes of the two-step smoothing. This is because the smooth data processing will enable the first Eve_Win pieces of runoff data), y_{2,1}, y_{2,2}, . . . , y_{2,Eve_Win} and the last Eve_Win pieces of runoff data y_{2,n-Eve_Win+1}, y_{2,n-Eve_Win+2}, . . . , y_{2,n} to be distorted.

In some optional specific embodiments, the first condition further includes an absolute value of the first first-order difference value and an absolute value of a first-order difference value next to the first first-order difference value being both greater than a preset threshold. For example, in a case where the preset threshold is 0.01, that is, |y_{2,j}¹|≥0.01, |y_{2,j+1}¹|≥0.01. Certainly, a preset threshold corresponding to the first first-order difference value and a preset threshold corresponding to the first-order difference value next to the first first-order difference value may be different or same.

In addition, the first condition may further include a product of the first first-order difference value and the first-order difference value next to the first first-order difference value being less than zero, that is, y_{2,j}¹·y_{2,j+1}¹<0.

Specifically, the initial peak occurrence time meeting the first condition above may be recorded as a set PeakIndex.

In some specific embodiments, the obtaining initial start and end time by using M continuous first-order difference values in the first-order difference sequence includes:
if a second first-order difference value corresponding to second runoff data in the runoff time sequence data and M−1 first-order difference values continuous with the second first-order difference value meet a second condition, determining that time corresponding to the second runoff data is initial start and end time, where the second condition includes the second first-order difference value and M/2−1 continuous first-order difference values before the second first-order difference value being all less than or equal to zero, and M/2 continuous first-order difference values after the second first-order difference value being all greater than or equal to zero, M being an even number greater than zero.

In other words, if y_{2,j}¹≥0, y_{2,j-1}¹≥0, y_{2,j-2}¹≥0, . . . , y_{2,j-M/2+1}¹≥0, and y_{2,j+1}¹≤0, y_{2,j+2}¹≤0, . . . y_{2,j+M/2}¹≤0, j is the start time or end time of a flood, where y_{2,j}¹ is the first first-order difference value, y_{2,j-1}¹, y_{2,j-2}¹, . . . , y_{2,j-M/2+1}¹ are the M/2−1 continuous first-order difference values before the first first-order difference value, and y_{2,j+1}, y_{2,j+2}¹, . . . , y_{2,j+M/2}¹ are the M/2 continuous first-order difference values after the second first-order difference value.

Specifically, the initial start and end time meeting the second condition above may be recorded as a set BottomIndex.

In some specific embodiments, the screening out determined peak occurrence time from the initial peak occurrence time, and screening out start and end time corresponding to the peak occurrence time from the initial start and end time includes:
screening out the initial peak occurrence time at which a corresponding runoff volume is greater than or equal to a preset flood peak threshold as the determined peak occurrence time;
screening out the initial start and end time earlier than and closest to the peak occurrence time as start time; and
screening out the initial start and end time later than and closest to the peak occurrence time as end time.

In this embodiment of the present disclosure, a flood peak threshold PeakThreshold is set, and peak occurrence time and corresponding start and end time of floods with peaks higher than the PeakThreshold are determined one by one by using the proximity principle. Specifically, for ∀t∈PeakIndex, t is taken as a center and serves as a peak occurrence time of a flood, and in the Bottom Index, a nearest point st=max{r:r<t,r∈BottomIndex} less than/is found to serve as start time of the flood, and a nearest point et=min{r:r>t,r∈BottomIndex} greater than 1 is found to serve as end time of the flood.

In some specific embodiments, the obtaining runoff time sequence data includes:
obtaining original runoff time sequence data; and
smoothing the original runoff time sequence data to obtain the runoff time sequence data;
where after screening out the determined peak occurrence time from the initial peak occurrence time, and screening out the start and end time corresponding to the peak occurrence time from the initial start and end time, the method further includes:
obtaining partial original runoff data between the start time and the end time from the original runoff time sequence data;
screening out a maximum runoff volume from the partial original runoff data; and
if the maximum runoff volume is greater than or equal to the preset flood peak threshold, determining that the maximum runoff volume is the flood peak discharge, and correcting the peak occurrence time to time corresponding to the maximum runoff volume.

In this embodiment of the present disclosure, because the data smoothing may cause the distortion of flood peak selection, the peak occurrence time and the flood peak discharge are corrected using the original runoff data.

$${t}_{new} = {arg max {x}_{j}}_{j ∈ [ st , et ]}$$

is calculated, and if the original runoff data corresponds to xₜ_{_{new}}≥PeakThreshold, eventually t_{new} is used as the peak occurrence time of the flood, and xₜ_{_{new}} is used as the corresponding flood peak discharge.

Further, the original runoff time sequence data may be preprocessed data. That is,

$${t}_{new} = {arg max {qx}_{j}}_{j ∈ [ st , et ]}$$

is calculated, and if the preprocessed runoff data corresponds to qxₜ_{_{new}}≥PeakThreshold, eventually t_{new} is used as the peak occurrence time of the flood, and qxₜ_{_{new}} is used as the corresponding flood peak discharge.

This embodiment of the present disclosure improves the accuracy and efficiency of identifying the multi-peak floods.

A flood event identification method provided by an embodiment of the present disclosure is described below by using collected actual runoff data of a hydrological station.

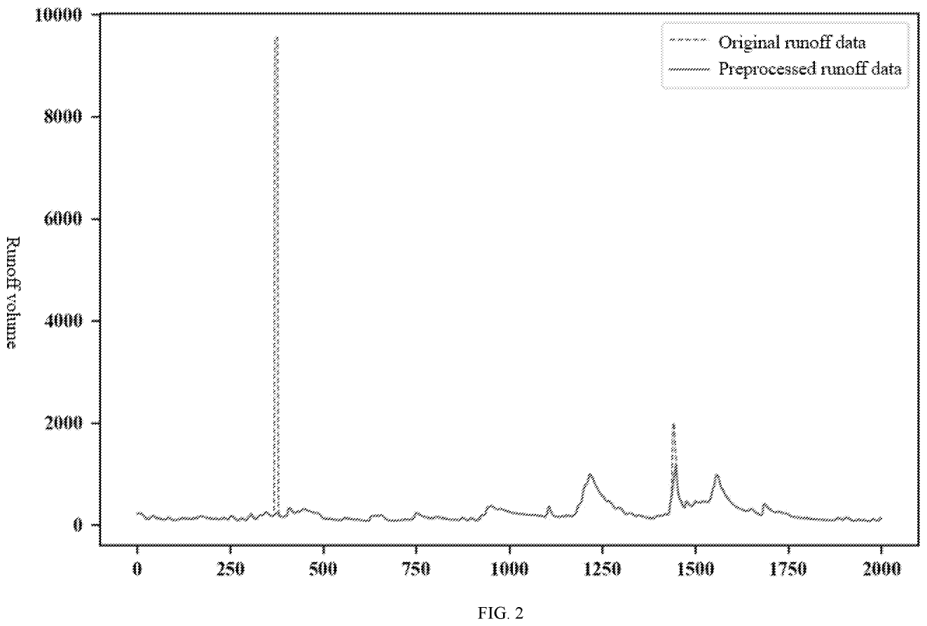

(1) Runoff data is obtained. A hourly runoff data sequence x₁, x₂, . . . , xₙ of a hydrological station is obtained, where n=2,000 (referring to the original runoff data in FIG. 2).

(2) The data is preprocessed. Abnormal mutation point detection is performed on the runoff sequence data manually, abnormal points are removed and marked as missing data, and then linear interpolation is performed on the missing data to obtain preprocessed data qx₁, qx₂, . . . , qxₙ (referring to the preprocessed runoff data in FIG. 2).

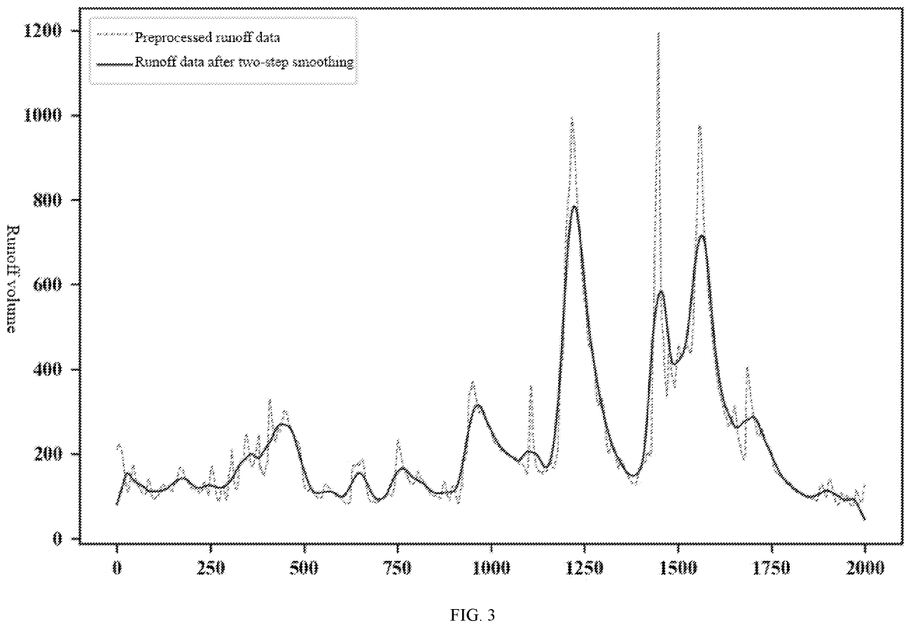

(3) Two-step smoothing is performed on the data. Window sizes win1=24, win2=48 of smoothing are set to obtain a data sequence y_{2,1}, y_{2,2}, . . . y_{2,n} after two-step smoothing (referring to the runoff data after two-step smoothing in FIG. 3).

(4) a condition that M=12, N=12 is set, that is, possible peak occurrence time and start and end time of all flood events are found by using six points before and after a first-order difference, and initial peak occurrence time set PeakIndex and initial start and end time set BottomIndex are obtained, where
PeakIndex={176, 244, 359, 440, 568, 648, 764, 965, 1100, 1223, 1455, 1564, 1700, 1896}, BottomIndex={91, 219, 274, 376, 535, 599, 700, 858, 1072, 1147, 1380, 1490, 1657, 1853, 1950}.

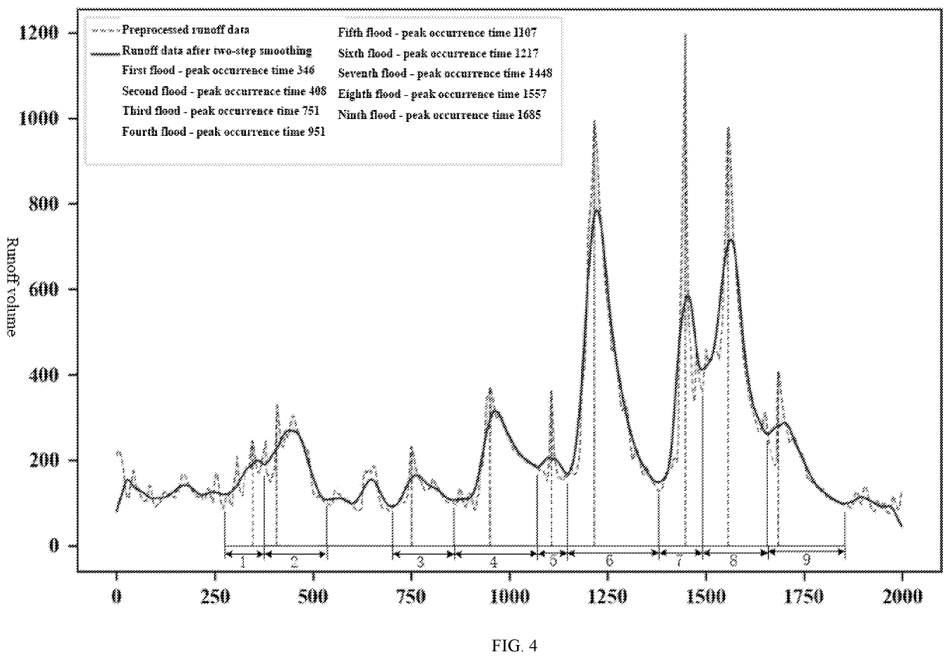

(5) Flood events are selected. A flood peak threshold PeakThreshold=200 is set, peak occurrence time and corresponding start and end time of all flood events are determined by using the proximity principle to obtain a total of nine floods, and corresponding results (referring to FIG. 4) are as follows:

TABLE 1
Flood event selection result

| Flood event | Peak occurrence | | |
|---|---|---|---|
| number | time | Start time | End time |
| 1 | 346 | 274 | 376 |
| 2 | 408 | 376 | 535 |
| 3 | 751 | 700 | 858 |
| 4 | 951 | 858 | 1072 |
| 5 | 1107 | 1072 | 1147 |
| 6 | 1217 | 1147 | 1380 |
| 7 | 1448 | 1380 | 1490 |
| 8 | 1557 | 1490 | 1657 |
| 9 | 1685 | 1657 | 1853 |

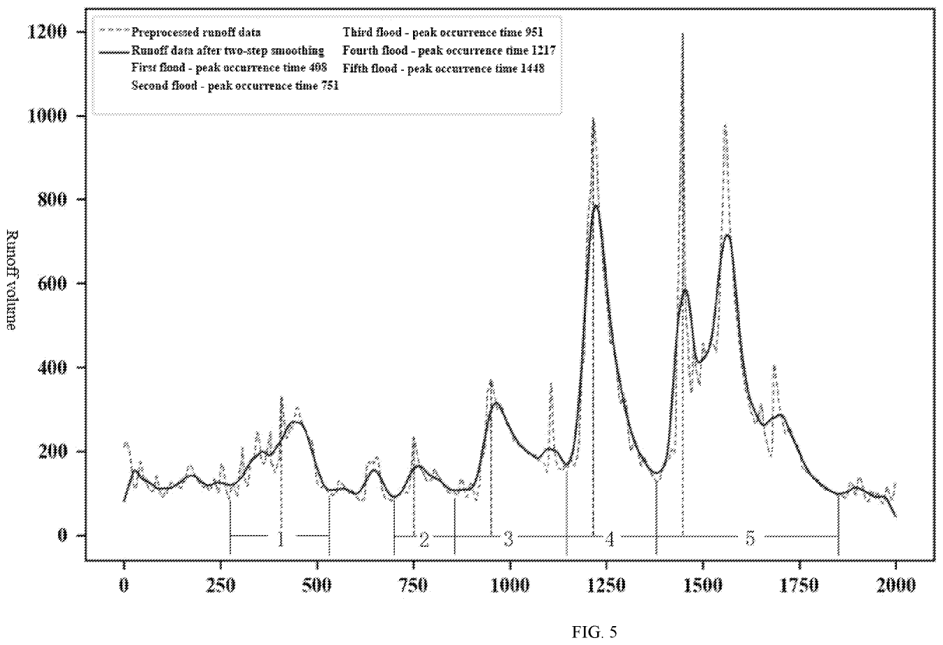

(6) Difference multiple thresholds α=1.1 of flood peak discharges and fluctuation point discharges are set, an average duration of flood events that is determined by characteristics of a river basin is T=3, multi-peak floods are identified and combined, and finally five floods are selected (as shown in Table 2, referring to FIG. 5).

TABLE 2
Multi-peak flood selection result

| Flood event | Peak occurrence | | |
|---|---|---|---|
| number | time | Start time | End time |
| 1 | 408 | 274 | 535 |
| 2 | 751 | 700 | 858 |
| 3 | 951 | 858 | 1147 |
| 4 | 1217 | 1147 | 1380 |
| 5 | 1448 | 1380 | 1853 |

In summary, in this embodiment of the present disclosure, the peak occurrence time and the start and end time of the floods are determined by using value changes in a plurality of first-order difference point intervals of the runoff data sequence in combination with the runoff data processing method based on two-step smoothing, the flood peaks are accurately identified by using the flood peak threshold and the original data, and the multi-peak floods are determined in combination with the difference multiples of the fluctuation point discharges of the flood events and the original data, thus solving the technical problems of a non-smooth data sequence, inaccurate flood peak determination, and difficulty in quickly identifying multi-peak floods, and effectively improving the efficiency and accuracy of flood event selection.

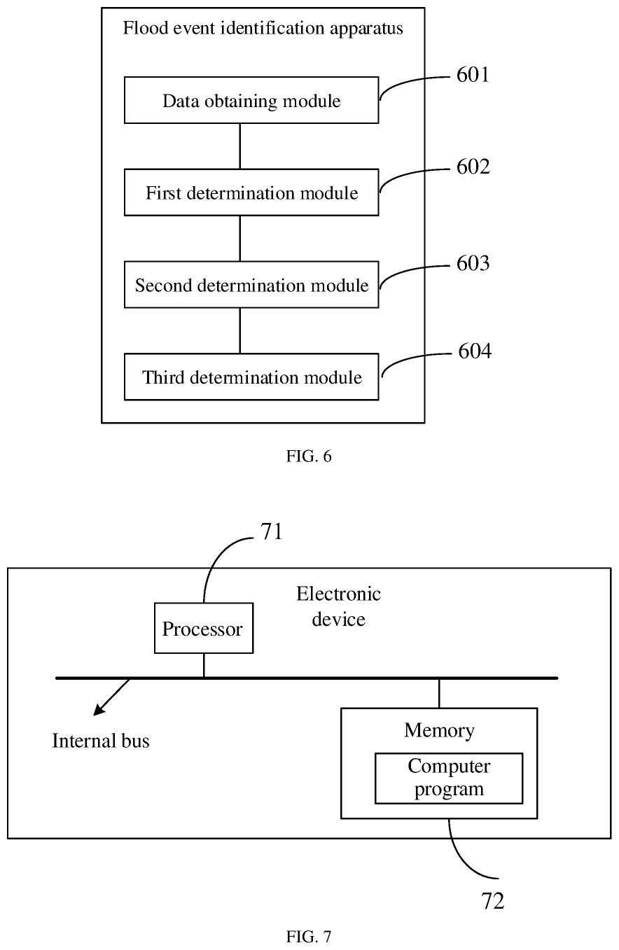

Correspondingly, referring to FIG. 6, an embodiment of the present disclosure provides a flood event identification apparatus, including:
a data obtaining module 601 configured to obtain runoff time sequence data;
a first determination module 602 configured to obtain initial peak occurrence time by using N continuous first-order difference values in a first-order difference sequence of the runoff time sequence data, where N is a positive integer;
a second determination module 603 configured to obtain initial start and end time by using M continuous first-order difference values in the first-order difference sequence, where M is a positive integer; and
a third determination module 604 configured to screen out determined peak occurrence time from the initial peak occurrence time, and screen out start and end time corresponding to the peak occurrence time from the initial start and end time.

According to the flood event identification apparatus provided by this embodiment of the present disclosure, the initial peak occurrence time is obtained by using the N continuous first-order difference values in the first-order difference sequence of the runoff time sequence data, the initial start and end time is obtained by using the M continuous first-order difference values in the first-order difference sequence, and finally the determined peak occurrence time is screened out from the initial peak occurrence time, and the start and end time corresponding to the peak occurrence time is screened out from the initial start and end time, such that flood events can be automatically selected with high efficiency and accuracy.

In some specific embodiments, the first determination module 602 includes:
a first determination unit configured to determine, if a first first-order difference value corresponding to first runoff data in the runoff time sequence data and N−1 first-order difference values continuous with the first first-order difference value meet a first condition, that time corresponding to the first runoff data is initial peak occurrence time, where the first condition includes the first first-order difference value and N/2−1 continuous first-order difference values before the first first-order difference value being all greater than or equal to zero, and N/2 continuous first-order difference values after the first first-order difference value being all less than or equal to zero, N being an even number greater than zero.

In some specific embodiments, the first condition further includes an absolute value of the first first-order difference value and an absolute value of a first-order difference value next to the first first-order difference value being both greater than a preset threshold.

In some specific embodiments, the second determination module 603 includes:
a second determination unit configured to determine, if a second first-order difference value corresponding to second runoff data in the runoff time sequence data and M−1 first-order difference values continuous with the second first-order difference value meet a second condition, that time corresponding to the second runoff data is initial start and end time, where the second condition includes the second first-order difference value and M/2−1 continuous first-order difference values before the second first-order difference value being all less than or equal to zero, and M/2 continuous first-order difference values after the second first-order difference value being all greater than or equal to zero, M being an even number greater than zero.

In some specific embodiments, the third determination module 604 includes:
a first screening unit configured to screen out the initial peak occurrence time at which a corresponding runoff volume is greater than or equal to a preset flood peak threshold as the determined peak occurrence time;
a second screening unit configured to screen out the initial start and end time earlier than and closest to the peak occurrence time as start time; and
a third screening unit configured to screen out the initial start and end time later than and closest to the peak occurrence time as end time.

In some specific embodiments, the data obtaining module 601 includes:
an original data obtaining unit configured to obtain original runoff time sequence data; and
a smoothing unit configured to smooth the original runoff time sequence data to obtain the runoff time sequence data.

The apparatus further includes:
a selection module configured to obtain partial original runoff data between the start time and the end time from the original runoff time sequence data;
a screening module configured to screen out a maximum runoff volume from the partial original runoff data; and
a correction module configured to determine, if the maximum runoff volume is greater than or equal to the preset flood peak threshold, that the maximum runoff volume is the flood peak discharge, and correct the peak occurrence time to time corresponding to the maximum runoff volume.

In some specific embodiments, the apparatus further includes:
a flood peak discharge determination module configured to determine a flood peak discharge corresponding to the peak occurrence time;
a difference multiple obtaining module configured to respectively obtain difference multiples of flood peak discharges and fluctuation point discharges of two continuous floods, where each of the difference multiples is a multiple obtained by dividing a first difference by a second difference; for a previous flood, the first difference is a difference between the flood peak discharge and a start discharge, and the second difference is a difference between the flood peak discharge and an end discharge; and for a next flood, the first difference is a difference between the flood peak discharge and an end discharge, and the second difference is a difference between the flood peak discharge and a start discharge; and
a determination module configured to determine, if the two difference multiples are both greater than or equal to a difference multiple threshold, the start discharge of the previous flood is less than or equal to the end discharge, the start discharge of the next flood is greater than or equal to the end discharge, and a difference between start time of the next flood and end time of the previous flood is less than or equal to an average duration of flood events that is determined based on characteristics of a river basin, that the two floods are multi-peak floods.

This embodiment of the present disclosure is an apparatus embodiment based on the same inventive concept as the above method embodiment. Hence, for specific technical details and corresponding technical effects, reference can be made to the above method embodiment, and a detailed description will not be repeated herein.

An embodiment of the present disclosure further provides an electronic device. As shown in FIG. 7, the electronic device may include a processor 71 and a memory 72, where the processor 71 and the memory 72 may be in communication connection with each other by a bus or in other ways. The connection by the bus is used as an example in FIG. 7.

The processor 71 may be a central processing unit (CPU). The processor 71 may also be a chip such as another general-purpose processor, a digital signal processor (DSP), an application specific integrated circuit (ASIC), a field-programmable gate array (FPGA) or another programmable logic device, a discrete gate or a transistor logic device, or a discrete hardware component, or a combination thereof.

The memory 72, as a non-transient computer-readable storage medium, may be configured to store non-transient software programs, non-transient computer executable programs and modules, such as program instructions/modules (such as the data obtaining module 601, the first determination module 602, the second determination module 603, and the third determination module 604 shown in FIG. 6) in this embodiment of the present disclosure that correspond to the flood event identification method. The processor 71 executes various functional applications and data processing of the processor by running the non-transient software programs, instructions and modules stored in the memory 72, that is, implements the flood event identification method in the above method embodiment.

The memory 72 may include a program storage area and a data storage area, where the program storage area may store an operating system and an application program required for at least one function; and the data storage area may store data and the like created by the processor 71. In addition, the memory 72 may include a high speed random access memory, and may further include a non-transient memory, such as at least one disk storage device, a flash memory device, or other non-transient solid state storage devices. In some embodiments, the memory 72 optionally includes a memory remotely disposed with respect to the processor 71, and these remote memories may be connected to the processor 71 through a network. Examples of the network above include, but are not limited to, the Internet, an intranet, a local area network, a mobile communication network, and a combination thereof.

The one or more modules are stored in the memory 72, and perform, when executed by the processor 71, the flood event identification method in the embodiments as shown in FIGS. 1 to 5.

Specific details of the electronic device above can be understood with reference to corresponding related descriptions and effects in the embodiments shown in FIG. 1 to FIG. 5, and will not be repeated herein.

Correspondingly, an embodiment of the present disclosure further provides a computer-readable storage medium, where the computer-readable storage medium is configured to store a computer program, and when the computer program is executed by a processor, the processes of the above flood event identification method embodiment are implemented, and the same technical effects can be achieved and will not be repeated herein in order to avoid repetition.

The computer-readable medium includes persistent and non-persistent media and removable and non-removable media, which can implement information storage by any method or technology. Information may be computer-readable instructions, data structures, program modules, or other data. Examples of the computer storage medium include, but are not limited to, a phase change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memories, a compact disc read-only memory (CD-ROM), a digital versatile disc (DVD) or other optical storages, a cassette magnetic tape, and a magnetic tape and disk storage or other magnetic storage devices or any other non-transmission media, which may be configured to store information accessible for a computing device. As defined herein, the computer-readable medium does not include transitory media, such as modulated data signals and carrier waves.

Each embodiment in this description is described in a progressive manner, the same and similar parts between the embodiments may be referred to each other, and each embodiment emphatically describes the difference from another embodiment. In particular, a system embodiment is basically similar to the method embodiment, so a simple description is provided, and for related parts, reference can be made to the partial description of the method embodiment.

The above are only the embodiments of the present disclosure and are not intended to limit the present disclosure. For those skilled in the art, the present application may have various modifications and changes. Any modifications, equivalent substitutions, improvements and the like made within the spirit and principle of the present application should be included within the scope of the claims of the present application.

1. A flood event identification method, comprising:
obtaining runoff time sequence data;
obtaining initial peak occurrence time by using N continuous first-order difference values in a first-order difference sequence of the runoff time sequence data, wherein N is a positive integer;
obtaining initial start and end time by using M continuous first-order difference values in the first-order difference sequence, wherein M is a positive integer; and
screening out determined peak occurrence time from the initial peak occurrence time, and screening out start and end time corresponding to the peak occurrence time from the initial start and end time;
wherein after screening out the determined peak occurrence time from the initial peak occurrence time, and screening out the start and end time corresponding to the peak occurrence time from the initial start and end time, the method further includes:
determining a flood peak discharge corresponding to the peak occurrence time;
respectively obtaining difference multiples of flood peak discharges and fluctuation point discharges of two continuous floods, wherein each of the difference multiples is a multiple obtained by dividing a first difference by a second difference; for a previous flood, the first difference is a difference between the flood peak discharge and a start discharge, and the second difference is a difference between the flood peak discharge and an end discharge; and for a next flood, the first difference is a difference between the flood peak discharge and an end discharge, and the second difference is a difference between the flood peak discharge and a start discharge; and
if the two difference multiples are both greater than or equal to a difference multiple threshold, the start discharge of the previous flood is less than or equal to the end discharge, the start discharge of the next flood is greater than or equal to the end discharge, and a difference between start time of the next flood and end time of the previous flood is less than or equal to an average duration of flood events that is determined based on characteristics of a river basin, determining that the two floods are multi-peak floods.

2. The method according to claim 1, wherein the obtaining initial peak occurrence time by using N continuous first-order difference values in a first-order difference sequence of the runoff time sequence data comprises:
if a first first-order difference value corresponding to first runoff data in the runoff time sequence data and N−1 first-order difference values continuous with the first first-order difference value meet a first condition, determining that time corresponding to the first runoff data is initial peak occurrence time, wherein the first condition includes the first first-order difference value and N/2−1 continuous first-order difference values before the first first-order difference value being all greater than or equal to zero, and N/2 continuous first-order difference values after the first first-order difference value being all less than or equal to zero, N being an even number greater than zero.

3. The method according to claim 2, wherein the first condition further comprises an absolute value of the first first-order difference value and an absolute value of a first-order difference value next to the first first-order difference value being both greater than a preset threshold.

4. The method according to claim 1, wherein the obtaining initial start and end time by using M continuous first-order difference values in the first-order difference sequence comprises:
if a second first-order difference value corresponding to second runoff data in the runoff time sequence data and M−1 first-order difference values continuous with the second first-order difference value meet a second condition, determining that time corresponding to the second runoff data is initial start and end time, wherein the second condition includes the second first-order difference value and M/2−1 continuous first-order difference values before the second first-order difference value being all less than or equal to zero, and M/2 continuous first-order difference values after the second first-order difference value being all greater than or equal to zero, M being an even number greater than zero.

5. The method according to claim 1, wherein the screening out determined peak occurrence time from the initial peak occurrence time, and screening out start and end time corresponding to the peak occurrence time from the initial start and end time comprises:
screening out the initial peak occurrence time at which a corresponding runoff volume is greater than or equal to a preset flood peak threshold as the determined peak occurrence time;
screening out the initial start and end time earlier than and closest to the peak occurrence time as start time; and
screening out the initial start and end time later than and closest to the peak occurrence time as end time.

6. The method according to claim 1, wherein the obtaining runoff time sequence data comprises:
obtaining original runoff time sequence data; and
smoothing the original runoff time sequence data to obtain the runoff time sequence data;
wherein after screening out the determined peak occurrence time from the initial peak occurrence time, and screening out the start and end time corresponding to the peak occurrence time from the initial start and end time, the method further includes:
obtaining partial original runoff data between the start time and the end time from the original runoff time sequence data;
screening out a maximum runoff volume from the partial original runoff data; and
if the maximum runoff volume is greater than or equal to the preset flood peak threshold, determining that the maximum runoff volume is the flood peak discharge, and correcting the peak occurrence time to time corresponding to the maximum runoff volume.

7. A flood event identification apparatus, comprising:
a data obtaining module configured to obtain runoff time sequence data;
a first determination module configured to obtain initial peak occurrence time by using N continuous first-order difference values in a first-order difference sequence of the runoff time sequence data, wherein N is a positive integer;
a second determination module configured to obtain initial start and end time by using M continuous first-order difference values in the first-order difference sequence, wherein M is a positive integer; and
a third determination module configured to screen out determined peak occurrence time from the initial peak occurrence time, and screen out start and end time corresponding to the peak occurrence time from the initial start and end time;
a flood peak discharge determination module configured to determine a flood peak discharge corresponding to the peak occurrence time;
a difference multiple obtaining module configured to respectively obtain difference multiples of flood peak discharges and fluctuation point discharges of two continuous floods, wherein each of the difference multiples is a multiple obtained by dividing a first difference by a second difference; for a previous flood, the first difference is a difference between the flood peak discharge and a start discharge, and the second difference is a difference between the flood peak discharge and an end discharge; and for a next flood, the first difference is a difference between the flood peak discharge and an end discharge, and the second difference is a difference between the flood peak discharge and a start discharge; and
a determination module configured to determine, if the two difference multiples are both greater than or equal to a difference multiple threshold, the start discharge of the previous flood is less than or equal to the end discharge, the start discharge of the next flood is greater than or equal to the end discharge, and a difference between start time of the next flood and end time of the previous flood is less than or equal to an average duration of flood events that is determined based on characteristics of a river basin, that the two floods are multi-peak floods.
